(19) United States
(12) Patent Application Publication
(10) Pub. No.: US 2026/0348361 A1
(43) Pub. Date: Nov. 5, 2026

(54) PLANETARY GEARBOX AND WIND POWER APPARATUS

(71) Applicant: Schaeffler Technologies AG & Co. KG, Herzogenaurach (DE)

(72) Inventors: Huimin Han, Shanghai (CN); Patrick Marsollek, Fürth (DE); Xiangke Chen, Shanghai (CN)

(73) Assignee: Schaeffler Technologies AG & Co. KG, Herzogenaurach (DE)

(21) Appl. No.: 18/997,309

(22) PCT Filed: Jul. 22, 2022
(86) PCT No.: PCT/CN2022/107375

§ 371 Date: Jan. 21, 2025

(51) Int. Cl. F03D 15/10; F03D 80/70

(52) U.S. Cl. CPC F03D 15/101; F03D 80/707; F05B 2280/6011

(57) ABSTRACT

The present invention relates to a planetary gearbox for a wind power apparatus, including a planetary shaft (10), a planetary gear (50) and a planetary carrier (60). The planetary shaft (10) is mounted on the planetary carrier (60), and the planetary gear (50) is mounted on the planetary shaft (10). A modification area (101, 102, 501, 502) is provided on an inner circumferential surface of the planetary gear (50) and/or an outer circumferential surface of the planetary shaft (10) in an axial contact area between the planetary gear (50) and the planetary shaft (10).

### CROSS-REFERENCE TO RELATED APPLICATIONS

This application is a U.S. national stage application under 35 U.S.C. § 371 that claims the benefit of priority under 35 U.S.C. § 365 of International Patent Application No. PCT/CN2022/107375, filed on Jul. 22, 2022, designating the United States of America, the contents of which are relied upon and incorporated herein by reference in their entirety.

### FIELD OF THE DISCLOSURE

The present disclosure relates to a planetary gearbox applied to the technical field of wind power generation. In particular, the present disclosure relates to a planetary shaft in the planetary gearbox.

### BACKGROUND OF THE DISCLOSURE

With the development of offshore wind power generation, large-megawatt wind turbines have become the trend for the future. Furthermore, the reduction of the levelized cost of electricity poses higher requirements for the cost and operational reliability of a gearbox. As an important component of the gearbox, a bearing is subject to higher requirements for its size and bearing capacity. Failure of a rolling bearing causes failure of the wind turbine gearbox, leading to a huge waste of time, and cost for maintenance.

WO 03/014 567 A1 discloses a wind power apparatus that includes a nacelle that is rotatably mounted on a tower and is provided with a generator for producing electricity, a rotor that bears a rotor hub with at least two rotor blades and is driven by wind, and a large rolling bearing that bears the rotor. In addition, a planetary gear transmission unit is connected to the generator in the nacelle and consists of a ring gear with circumferential internal teeth, multiple planetary gears supported by a planetary carrier, and a sun gear in the center in a conventional manner. The large rolling bearing is connected to the planetary gear transmission unit in such a way that an inner ring of two bearing rings of the large rolling bearing is press-fit onto an outer surface of the ring gear of the planetary gear transmission unit to be connected and fixed thereto. Moreover, EP 811 764 A1 also discloses such connection manner between the large rolling bearing and the planetary gear transmission unit, where the inner ring of the two bearing rings of the large rolling bearing is pressed onto a ring that is connected to the rotor hub and bears the planetary carrier.

The wind power apparatus in the conventional technology has the following disadvantages. The large rolling bearing and the planetary gear transmission unit connected behind it consist of a number of individual components, resulting in not only huge manufacturing cost but also a large total weight, which causes many drawbacks when the large rolling bearing and the planetary gear transmission unit are assembled in the nacelle at a height of up to 120 m. Moreover, the ring gear of the planetary gear transmission unit and the inner ring of the large rolling bearing are supposed to have an outer diameter or an inner diameter of 2 m or above. The size may be precise after manufacturing, so that it is possible to reliably prevent a negative impact on a function of a journal or on the teeth of the planetary gear transmission unit applied by excessive or inadequate press-fitting between the inner bearing ring and the ring gear. However, the planetary gear is still likely to move due to a gap during operation, which adds a relatively large radial load to the planetary shaft, and may easily damage the parts. There may also be a gap between the planetary gear and the planetary shaft, leading to the same technical problem.

### SUMMARY OF THE DISCLOSURE

Therefore, a technical problem to be solved by the present disclosure is how to provide a planetary gearbox to reduce the above disadvantages of the conventional technology.

The technical problem is solved by a planetary gearbox for a wind power apparatus according to the present disclosure. The planetary gearbox includes a planetary shaft, a planetary gear and a planetary carrier. The planetary shaft is mounted on the planetary carrier, and the planetary gear is mounted on the planetary shaft. A modification area is provided on an inner circumferential surface of the planetary gear and/or an outer circumferential surface of the planetary shaft in an axial contact area between the planetary gear and the planetary shaft. The modification area refers to an area that is provided with a special structure, such as a wedge structure, so that an oil film forms in the contact area between the planetary gear and the planetary shaft. Oil pressure can better bear a load from the planetary gear, thereby reducing the edge stress concentration and improving the service life of the system.

The modification area is preferably provided with an oil storage tank, which can store lubricating oil, so that the oil film forms better. Further, the modification area is preferably provided with hard coating or bronze cladding, which can enhance the wear resistance of the modification area, so as to reduce the maintenance cost. The specific structure of the modification area is not limited in the present disclosure, as long as the oil film can form.

According to a preferred implementation of the present disclosure, a circumferential oil groove is provided in the middle of the axial contact area between the planetary gear and the planetary shaft. A first contact area and a second contact area are provided on respective sides of the circumferential oil groove in an axial direction, and the modification area is provided in the first contact area and/or the second contact area. The oil groove in the middle can supply the lubricating oil to the whole contact area uniformly. The oil groove in the middle divides the functional area into two areas in the axial direction, namely the first contact area and the second contact area. A first modification area and a second modification area are respectively provided in the two contact areas. Each of the two modification areas may be provided in a part of a corresponding one of the two contact areas or all of the corresponding functional area. Moreover, positions and areas of the first modification area and the second modification area are preferably determined according to actual operating conditions of the planetary gearbox. The modification areas may be symmetrical or asymmetrical to adapt to various operating conditions, reduce the edge stress concentration, and enhance the bearing capacity of a hydrodynamic bearing, which may be determined according to the load on the planetary shaft under actual operating conditions. For example, in a case that the load applied on the planetary shaft is even in the axial direction, the first modification area and the second modification area are symmetric to each other with respect to the circumferential oil groove in the axial direction, thereby reducing the edge stress concentration and improving the service life of the system.

According to another preferred implementation of the present disclosure, an axial bearing member is provided on the planetary shaft at one end or both ends of the planetary gear in the axial direction. An axial modification area is provided on an end face of the axial bearing member in contact with the planetary gear. Whether the axial modification area is provided on the one end or both ends of the planetary gear depends on the wind power apparatus and the assembly structure of the gearbox. If the planetary gear is movable along both directions of the axial direction, then the axial modification area is preferably provided on the end face of each of the axial bearing members in contact with the planetary gear. If the planetary gear moves along only one direction of the axial direction, then the modification area needs to be provided only on the axial bearing member in the moving direction. Moreover, the axial bearing member may preferably be a shaft shoulder of the planetary shaft, or a bearing, or a ring. The function of bearing an axial load is transferred from the wind power gearbox to the planetary shaft, and the function of an axial hydrodynamic plain bearing is achieved by the shaft shoulder. Alternatively, the functions may be achieved by a replaceable bearing or ring component. If the axial bearing member is the shaft shoulder, the planetary shaft can bear not only a radial load but also the axial load in one direction. This allows an additional thrust bearing to be removed from one side, which reduces the number of the components, and thereby reduces the cost. If the axial bearing member is the bearing or the ring, which has a simple structure and is cheap, the cost can be reduced and replacement is easy.

Moreover, the technical problem to be solved by the present disclosure can also be solved by a wind power apparatus that is provided with the planetary gearbox including the technical features described hereinabove.

### BRIEF DESCRIPTION OF THE DRAWINGS

The present disclosure is further described below in conjunction with the accompanying drawings. The same reference numerals in the drawings indicate components with the same or similar functions. Drawings are as follows:

FIG. 1 shows a sectional view of the planetary gearbox according to the present disclosure;

FIG. 2a shows a perspective view of a planetary shaft according to a first embodiment of the present disclosure;

FIG. 2b shows a perspective view of a planetary shaft according to a second embodiment of the present disclosure;

FIG. 2c shows a perspective view of a planetary shaft according to a third embodiment of the present disclosure; and

FIG. 3 shows a perspective view and a sectional view of a planetary gear according to the present disclosure.

### DETAILED DESCRIPTION

Specific implementations of a planetary gearbox according to the present disclosure will be described below in conjunction with the accompanying drawings. The following detailed description and drawings are intended to exemplarily illustrate the principle of the present disclosure. The present disclosure is not limited to the described preferred embodiments, and the scope of protection of the present disclosure is defined by the claims.

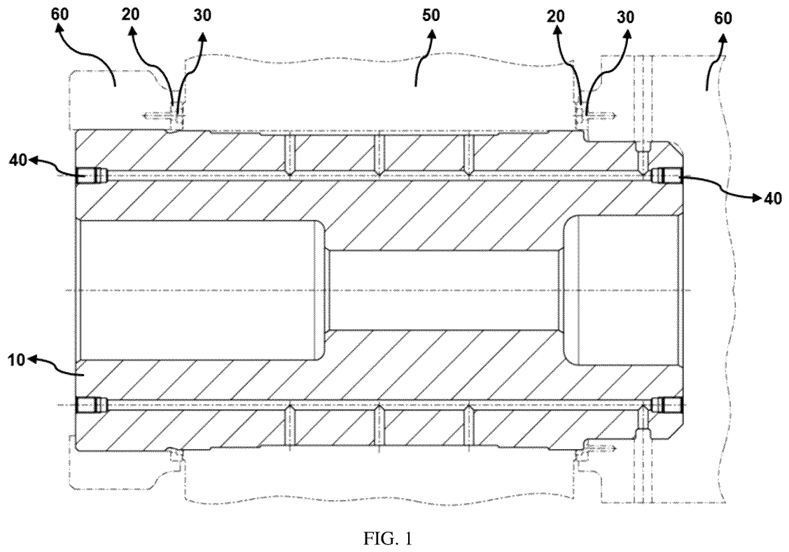

FIG. 1 shows a sectional view of the planetary gearbox according to the present disclosure. The planetary gearbox is provided with a planetary shaft 10, a hydrodynamic thrust bearing 20, a planetary gear 50 and a planetary carrier 60. The hydrodynamic thrust bearing 20 is fixed on the planetary carrier 60 through a pin 30. According to another implementation, the planetary shaft 10 is provided with a shaft shoulder for limiting the planetary gear 50 in an axial direction. In this way, two ends of the planetary gear 50 in the axial direction are in contact with the shaft shoulder and the hydrodynamic thrust bearing 20 respectively. Each of the shaft shoulder and the hydrodynamic thrust bearing 20 is provided with an axial end face that is in contact with the planetary gear 50 in the axial direction, and the axial end face is provided with a modification. The main principle of the modification area is to form pressure variation on a contact surface, so that an oil film forms at a contact position, thereby forming oil pressure to bear an axial load.

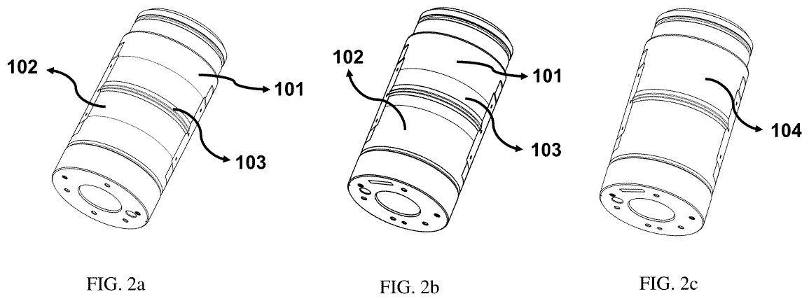

FIG. 2a shows a perspective view of a planetary shaft according to a first embodiment of the present disclosure. A circumferential oil groove 103 is provided in the middle of a functional surface (i.e., an area in contact with the planetary gear 50 in the axial direction) of the planetary shaft 10. A first contact area and a second contact area are respectively provided on left and right sides of the circumferential oil groove 103 in the axial direction. A first modification area 101 is provided in the first contact area, and a second modification area 102 is provided in the second contact area. The first modification area 101 and the second modification area 102 are symmetric to each other with respect to the circumferential oil groove 103. Such design is applicable for operating conditions with little or no load offset.

FIG. 2b shows a perspective view of a planetary shaft according to a second embodiment of the present disclosure. This embodiment is substantially similar to the first embodiment, and differs from the first embodiment in that the first modification area 101 and the second modification area 102 are not symmetric to each other, that is, the modification areas have different lengths on the functional surface in the axial direction. Such design is applicable for operating conditions with large load offset. Areas and positions of the first modification area 101 and the second modification area 102 are designed according to the operating conditions in specific applications. Moreover, radial sizes of the first modification area 101 and the second modification area 102 are not symmetric to each other (with respect to a middle position of the functional area). That is, the modifications have different sizes in a radial direction.

FIG. 2c shows a perspective view of a planetary shaft according to a third embodiment of the present disclosure. The entire functional surface 104 of the planetary shaft 10 is provided with the modification, which is designed according to the operating conditions in specific applications.

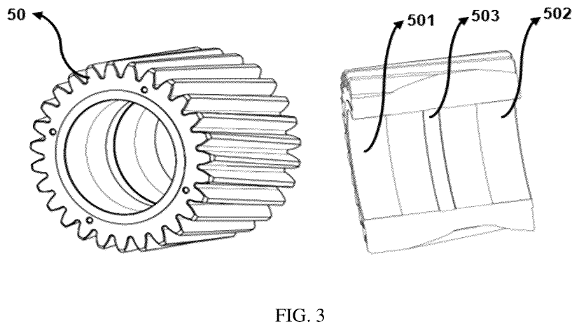

FIG. 3 shows a perspective view and a sectional view of a planetary gear according to the present disclosure. The modification may be provided on the planetary gear, as shown in FIG. 3. The design principle of the modification on the planetary gear is similar to that of the modification on the planetary shaft. A circumferential oil groove 503 is provided on an inner circumferential surface of the planetary gear. A first contact area and a second contact area are respectively provided on left and right sides of the circumferential oil groove 503 in the axial direction. A first modification area 501 is provided in the first contact area, and a second modification area 502 is provided in the second contact area. The first modification area 501 and the second modification area 502 may be or may not be symmetric to each other with respect to a middle portion of the functional area. The modification area may be provided in a part of the functional area, or on the entire functional surface of the functional area. The modification is designed according to the operating conditions in specific applications.

Although possible embodiments have been described illustratively in the above description, it should be understood that there are still a large number of embodiment variations through combinations of all known technical features and embodiments as well as those that are readily apparent to those skilled in the art. In addition, it should be further understood that the exemplary embodiments are just examples and shall not in any way limit the scope of protection, application and construction of the present disclosure. The foregoing description is more intended to provide those skilled in the art with a technical guidance for implementing at least one exemplary embodiment, in which various changes, especially changes in the functions and structures of the components, can be made as long as they do not depart from the scope of protection of the claims.

### LIST OF REFERENCE NUMERALS

10 planetary shaft
20 hydrodynamic thrust bearing
30 pin
40 blocking screw
50 planetary gear
60 planetary carrier
101 first modification area
102 second modification area
103 circumferential oil groove
104 functional surface
501 first modification area
502 second modification area
503 circumferential oil groove

1. A planetary gearbox for a wind power apparatus, comprising a planetary shaft a planetary gear and a planetary carrier, wherein
the planetary shaft is mounted on the planetary carrier, and the planetary gear mounted on the planetary shaft; and
at least one modification area is provided on at least one of an inner circumferential surface of the planetary gear and an outer circumferential surface of the planetary shaft in an axial contact area between the planetary gear and the planetary shaft.

2. The planetary gearbox of claim 1, wherein
a circumferential oil groove is provided in the middle of the axial contact area between the planetary gear and the planetary shaft; and
the axial contact area includes a first contact area and a second contact area that are provided on respective axial sides of the circumferential oil groove, and the at least one modification area is provided in at least one of the first contact area and the second contact area.

3. The planetary gearbox of claim 2, wherein the at least one modification area includes a first modification area and a second modification area, and wherein the first modification area is provided in at least a portion of the first contact area, and the second modification area is provided in at least a portion of the second contact area.

4. (canceled)

5. The planetary gearbox of claim 3, wherein the first modification area and the second modification area are symmetric to each other with respect to the circumferential oil groove in the axial direction.

6. The planetary gearbox of claim 1, wherein the modification area is provided with an oil storage tank.

7. The planetary gearbox of claim 1, wherein the modification area is provided with at least one of a hard coating and a bronze cladding.

8. The planetary gearbox of claim 1, wherein an axial bearing member is provided on the planetary shaft at an end of the planetary gear in an axial direction, and an axial modification area is provided on an end face of the axial bearing member in contact with the planetary gear.

9. The planetary gearbox of claim 8, wherein the axial bearing member is one of a shaft shoulder of the planetary shaft, a bearing, and a ring.

10. (canceled)

11. A planetary gearbox, comprising:
a planetary carrier;
a planetary gear; and
a planetary shaft to which the planetary gear is mount and that is mounted on the planetary carrier, the planetary shaft having, on an outer circumferential surface of the planetary shaft, a first contact area for engaging an inner circumferential surface of the planetary gear, a second contact area for engaging the inner circumferential surface of the planetary gear, and a circumferentially extending oil groove disposed axially between the first and second contact areas, wherein the first contact area includes a first modification area that extends a first axial distance from the oil groove and is radially offset from a portion of the first contact area that is adjacent to the first modification area opposite the oil groove, and the second contact area includes a second modification area that extends a second axial distance from the oil groove and is radially offset from a portion of the second contact area that is adjacent to the second modification area opposite the oil groove.

12. The planetary gearbox of claim 11, wherein the first axial distance is less than the second axial distance.

13. The planetary gearbox of claim 11, wherein the first axial distance is equal to the second axial distance.

14. The planetary gearbox of claim 11, wherein the first modification area of the first contact area varies radially as it extends axially to form a wedge-like shape.

15. The planetary gearbox of claim 11, wherein the first and second modification areas of the first and second contact areas of the outer circumferential surface of the planetary shaft and in the inner circumferential surface of the planetary gear cooperate to form a storage oil tank.

16. The planetary gearbox of claim 11, wherein the first and second modification areas are provided with bronze cladding.

17. The planetary gearbox of claim 11, wherein the first and second modification areas are provided with a hard coating.
